(19) United States
(12) Patent Application Publication
(10) Pub. No.: US 2023/0342796 A1
(43) Pub. Date: Oct. 26, 2023

(54) METHOD AND SYSTEM FOR PREDICTING DEMAND FOR SUPPLY CHAIN

(71) Applicant: Wipro Limited, Bangalore (IN)

(72) Inventors: Manoj MADHUSUDHANAN, Hillsborough, NJ (US); Sreekumar CHOYARMADATHIL, Bangalore (IN); Uday Singh KEITH, Bangalore (IN); Rohan MADHUSUDHANAN, Bangalore (IN)

(21) Appl. No.: 18/193,330

(22) Filed: Mar. 30, 2023

(30) Foreign Application Priority Data
Apr. 20, 2022 (IN) 202241023237

(51) Int. Cl. G06Q 30/0202

(52) U.S. Cl. CPC G06Q 30/0202

(57) ABSTRACT

A method and a system for predicting demand for a supply chain is disclosed. The method includes feeding input vectors to a trained Machine Learning (ML) model, for a future time-period. The input vectors include an intensity vector corresponding to an intensity of a possible disruption-event at each point of time within the future time-period and a duration vector corresponding to the duration of the possible disruption-event, and one or more extrinsic data vectors. The method further includes obtaining a demand for a target product in the future time-period from the trained ML model based on the input vectors.

### TECHNICAL FIELD

This disclosure relates generally to demand prediction. More particularly, the invention relates to a method and a system for predicting demand for a supply chain using Machine Learning (ML).

### BACKGROUND

In supply chain, demand forecasting plays an important role for decision making. Demand forecasting is a process for estimating quantity of product or services in response to customer's demand. However, in the supply change, disruptive events often threaten accurate demand forecasting and Supply Chain Management (SCM) that rely on it. Currently, many demand sensing models exist that provide near-future demand forecast to help organizations to make short-term decisions. However, conventional demand sensing models are unable to capture impact of disruption that includes economic downturns, pandemics, technological innovations etc. In addition, these conventional demand sensing models are not able to effectively provide productive SCM guidance during disruptions. Moreover, these conventional demand sensing models rely heavily on historical demand time-series data to forecast future demand.

Since these conventional demand sensing models do not consider external variables, for example macroeconomic indicators while performing demand forecasting, hence these models are unable to capture impact of disruption events and are unable to provide effective SCM guidance. Moreover, the conventional demand sensing models are unable to capture the impact of disruption events as these disruptive events manifest with sparse time-series, making them difficult to model. In addition, the conventional demand sensing models requires frequent manual intervention to constantly adjust these models for different situations. Since none of the conventional demand sensing models are capable of accurately capturing disruption dynamics, thus resulting in misguided SCM for organizations. Consequences of misguided SCM include high inventory costs, consistent stock outs, poor pricing and product strategy.

Therefore, there is a need for a method and system that is robust and efficient for predicting demand for the supply chain.

### SUMMARY

In an embodiment, a method for predicting demand for a supply chain is disclosed. In one embodiment, the method may include feeding input vectors to a trained Machine Learning (ML) model for a future time-period. It should be noted that, the input vectors comprise at least one of: an intensity vector corresponding to an intensity of a possible disruption-event at each point of time within the future time-period, a duration vector corresponding to the duration of the possible disruption-event, and one or more extrinsic data vectors corresponding to one or more possible extrinsic data parameters associated with each point of time within the future time-period. The method may further include obtaining a demand for a target product in the future time-period from the trained ML model based on the input vectors.

In another embodiment, a system for predicting demand for a supply chain is disclosed. The system includes a processor and a memory communicatively coupled to the processor, wherein the memory stores processor-executable instructions, which, on execution, causes the processor to feed input vectors to a trained Machine Learning (ML) model for a future time-period. It should be noted that, the input vectors comprise at least one of: an intensity vector corresponding to an intensity of a possible disruption-event at each point of time within the future time-period, a duration vector corresponding to the duration of the possible disruption-event, and one or more extrinsic data vectors corresponding to one or more possible extrinsic data parameters associated with each point of time within the future time-period. The processor-executable instructions further cause the processor to obtain a demand for a target product in the future time-period from the trained ML model based on the input vectors.

In yet another embodiment, a non-transitory computer-readable medium storing computer-executable instruction for is disclosed. The stored instructions, when executed by a processor, may cause the processor to perform operations including feeding input vectors to a trained Machine Learning (ML) model for a future time-period. It should be noted that, the input vectors comprise at least one of: an intensity vector corresponding to an intensity of a possible disruption-event at each point of time within the future time-period, a duration vector corresponding to the duration of the possible disruption-event, and one or more extrinsic data vectors corresponding to one or more possible extrinsic data parameters associated with each point of time within the future time-period. The operations may further include obtaining a demand for a target product in the future time-period from the trained ML model based on the input vectors.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a system configured for predicting demand for a supply chain, in accordance with an embodiment.

FIG. 2 illustrates a functional block diagram of various modules of a system configured for predicting demand for a supply chain, in accordance with an embodiment.

FIG. 3 illustrates a flowchart of a method for predicting demand for a supply chain, in accordance with an embodiment.

FIG. 4 illustrates a flowchart of a method for generating training data vectors, in accordance with an embodiment.

FIG. 5 illustrates a flowchart of a method for training a Machine Learning (ML) based on a loss function, in accordance with an embodiment.

FIG. 6 illustrates a flowchart of a method for retraining a ML based on magnitude of error of prediction, in accordance with an embodiment.

FIG. 7 illustrates a detailed flowchart of a method of predicting demand for a supply chain, in accordance with an embodiment.

FIG. 8 illustrates a block diagram of an exemplary computer system for implementing embodiments consistent with the present disclosure.

### DETAILED DESCRIPTION

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

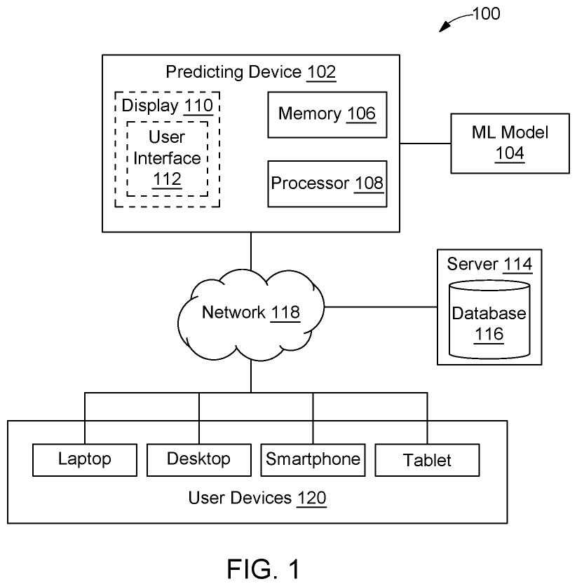

A system 100 configured for predicting demand for a supply chain is illustrated in FIG. 1. In particular, the system 100 may include a predicting device 102 that may be responsible for predicting demand in the supply chain. In order to predict demand in the supply chain, the predicting device 102 may feed input vectors to a trained Machine Learning (ML) model, i.e., a ML model 104. A method of training the ML model 104 has been further explained in detail in conjunction with other embodiments of present disclosure. In an embodiment, the input vectors may include an intensity vector, a duration vector, and one or more extrinsic data vectors. The intensity vector may be fed corresponding to an intensity of a possible disruption-event at each point of time within the future time-period. The duration vector may be fed corresponding to the duration of the possible disruption-event.

In addition, the one or more extrinsic data vectors may be fed corresponding to one or more possible extrinsic data parameters associated with each point of time within the future time-period. The extrinsic data parameters may include, but is not limited to, competitors and market data parameters, macroeconomic data parameters, socio-economic data parameters, and consumer-specific data parameters associated with a target industry. Upon feeding the input vectors, the predicting device 102 may obtain a demand for a target product in the future time-period from the trained ML model based on the input vectors. It should be noted that the, the target product may be associated with the target industry. Once the demand is obtained from the ML model 104, the predicting device 102 may compare the predicted demand with an actual demand via the ML model 104. The comparison may be done to determine a magnitude of error of prediction. Upon determining the magnitude of error of prediction, the predicting device 102 may retrain the ML model 104 based on the magnitude of error of prediction.

Examples of the predicting device 102 may include, but are not limited to, a server, a desktop, a laptop, a notebook, a tablet, a smartphone, a mobile phone, an application server, or the like. The predicting device 102 may further include a memory 106, a processor 108, and the display 110. The display 110 may further include a user interface 112. As described above, the user may interact with the predicting device 102 and vice versa through the display 110.

By way of an example, the display 110 may be used to display intermediate results (i.e., historical demand data, disruption data, one or more extrinsic data parameters, sparse multivariate time series, training data vectors, loss function, etc.,) based on actions performed by the predicting device 102, to a user. Moreover, the display 110 may be used to display final result, i.e., the demand obtained for the target product and the magnitude of error of prediction.

By way of another example, the user interface 112 may be used by the user to provide inputs to the predicting device 102. Thus, for example, in some embodiment, the user may ingest an input via the predicting device 102 that may include the input vectors. In another embodiment, the user may ingest input via the predicting device 102 that may include training data for training the ML model 104. Further, for example, in some embodiments, the predicting device 102 may render intermediate results (e.g., historical demand data, disruption data, one or more extrinsic data parameters, sparse multivariate time series, training data vectors, loss function, etc.,) or final results (e.g., the demand obtained for the target product and the magnitude of error of prediction) to the user via the user interface 112.

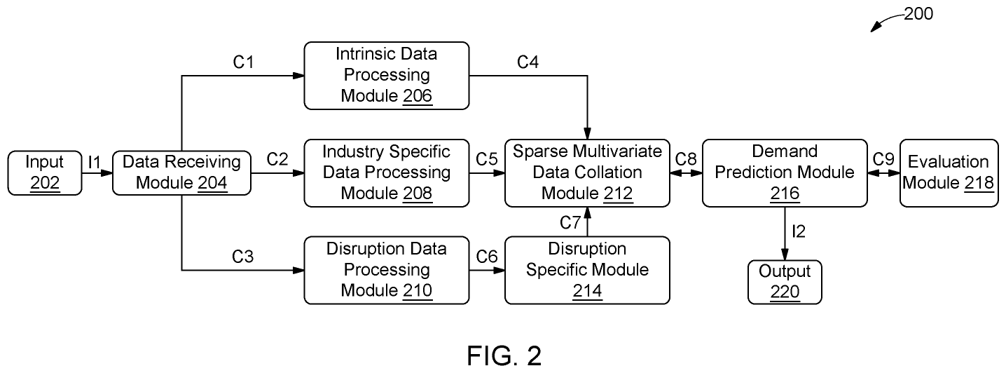

The memory 106 may store instructions that, when executed by the processor 108, may cause the processor 108 to obtain the demand for the target product. As will be described in greater detail in conjunction with FIG. 2 to FIG. 7, in order to obtain the demand for the target product, the processor 108 in conjunction with the memory 106 may perform various functions including feeding input vectors, obtaining the demand for the target product, comparing the predicted demand with the actual demand, determining the magnitude of error of prediction, etc.

The memory 106 may also store various data (e.g., the historical demand data, the disruption data, the one or more extrinsic parameters, the intensity vector, the duration vector, the one or more extrinsic data vectors, the demand obtain for the target product, etc.,) that may be captured, processed, and/or required by the predicting device 102. The memory 106, in some embodiments, may also include the trained ML model 104. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random-Access Memory (DRAM), Static Random-Access memory (SRAM), etc.).

Further, the predicting device 102 may interact with a server 114 or user devices 120 over a network 118 for sending and receiving various data. The user devices 120 may be used by a plurality of users to provide their inputs, such as, the input vectors, to the predicting device 102. Examples of the user devices 120 may include, but is not limited to, laptop, desktop, smartphone, tablet. The network 118, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

In some embodiment, the predicting device 102 may fetch the historical demand data, the disruption data, the one or more extrinsic data parameters from the server 114. In addition, the server 114 may provide access of information (i.e., the input vectors) to the user. The server 114 may further include a database 116. The database 116 may store the historical demand data, the disruption data, the one or for a reference time-period. By way of an example, the database 116 may store information associated disruption event such as economic downturns in market. The database 116 may be periodically updated with new information available for the disruption events.

Referring now to FIG. 2, a functional block diagram of various modules of a system 200 configured for predicting demand for a supply chain is illustrated, in accordance with an embodiment. In reference to FIG. 1, various modules of the system 200 may be present within the memory 106 of the predicting device 102. In an embodiment, the system 200 may include a data receiving module 204, an intrinsic data processing module 206, an industry specific data processing module 208, a disruption data processing module 210, a sparse multivariate data collation module 212, a disruption specific module 214, a demand prediction module 216, and an evaluation module 218. In addition, the system 200 may be configured to receive an input 202 and based on processing of the input 202 by the various modules 204-216 of the system 200, an output 220 may be generated.

Initially, the input 202 may be received by the data receiving module 204 via an interface ‘I1’. The input 202 may include intrinsic data and extrinsic data, such as, historical sales data (H), disruptive events data, and industry specific data (ID). In an embodiment, the historical sales data may also be referred as the historical demand data. Further, the disruptive events data may also be referred as the disruption data. In addition, the industry specific data may also be referred as the one or more extrinsic data parameters. This received input 202 may have to be collated in a sparse multivariate time series by the sparse multivariate data collation module 212. The collated data may be served as a feed to a neural network model at any point of time. In reference to FIG. 1, the neural network model may correspond to the ML model 104. Further, the neural network model may be a forward-looking model. Examples of the neural network model may include, but is not limited to, feedforward neural network model, multilayer perceptron's (MLPs) model, and quintessential deep learning model. As will be appreciated, number of nodes of the input 202 to the neural network model may be equivalent to aggregation of features derived from the input 202. By way of an example, the input 202 may be represented as depicted via equation (1) to equation (4). In an embodiment, the historical sales data, i.e., the historical demand data collected for the reference time-period may be represented as depicted via the equation (1) below:

Historical sales data,H:[H]_{(a×1)} (1)

In the equation (1), ‘[H]’ may represent the historical sales data as a time series and ‘a’ may represent each point in time within the reference time-period of the historical sales data. Further, the disruptive event data, i.e., the disruption data collected for the reference time-period may be represented as depicted via the equation (2) below:

Disruptive events data,DS:[I D]_{(a×2)} (2)

In equation (2), ‘I’ may represent an intensity of a disruption-event at each point of time within the reference time-period. In addition, ‘D’ may represent a duration of the disruption—event. Further, ‘a’ may represent each point in time within the reference time-period of the disruptive event data. Further, the industry specific data, i.e., the extrinsic data parameters may be represented as depicted via equation (3) below:

Industry Specific Data,ID:[CM,M,SE,C]_{(a×b)} (3)

In equation (3), ‘CM’ may correspond to competitors and market data parameters as a time series. ‘M’ may be macroeconomic data parameters as a time series. ‘SE’ may be socio-economic data parameters as a time series. And ‘C’ may be consumer specific data parameters as a time series. Further, ‘a’ may represent each point in time with the reference time-period of industry specific data and ‘b’ may be number of features derived from ‘CM’, ‘M’, ‘SE’, and ‘C’. Further, a final input, i.e., a training data vectors, that may be fed to the neural network model for training of the neural network model may be represented as depicted via equation (4) below:

Final Input,IN:[H I D ID]_{(a×(3+b))} (4)

In equation (4), the final input ‘IN’ may include a historical data vector, an intensity vector, a duration vector, and one or more extrinsic data vectors corresponding to one or more extrinsic data parameters at each point of time within the reference time-period. Further, (3+b) may be number of nodes of the final input derived from the historic sales data (H), the disruptive events data (DS), and the industry specific data (ID).

The data receiving module 204 may be configured to receive the input 202. In other words, the data receiving module 204 may the intrinsic data, i.e., data internal to an organization (i.e., the target industry) via the interface ‘I1’. In addition, the data receiving module 204 may receive extrinsic data, i.e., data external to the organization that can affect future demand. In an embodiment, the intrinsic data may include the historical demand data of the organization. The historical demand data may include store-level data, product-level data, and stock keeping unit (SKU) level data of various channels and regions of the organization. The intrinsic data received may be used to extract normal trends and patterns related with historical sales of the organization. Further, the extrinsic data may include the disruption data and the one or more extrinsic data parameters. The disruption data may include the intensity and the duration of the disruption event. In addition, the one or more extrinsic data parameters may include, competitors and market data parameter, macroeconomic data parameters, socio-economic data parameters, and consumer specific data parameters. The extrinsic data received may be used to sense deviations from normal trends and adjust demand forecasts accordingly. Upon receiving the input 202, the data receiving module 204 may be configured to provide the received input 202 to other corresponding modules of the system 200 for further processing.

The data receiving module 204 may provide the intrinsic data to the intrinsic data processing module 206 via a connection ‘C1’. Upon receiving the intrinsic data, the intrinsic data processing module 206 may be configured to process the intrinsic data in order to obtain the historical demand data as time series. In an embodiment, the historical demand data may include the store-level data, the product-level data, and the SKU—level data of various channels and regions of the organization. Upon obtaining the historical demand data as the time series, the intrinsic data processing module 206 may be configured to provide the obtained time series of the historical demand data to the sparse multivariate data collation module 212 via a connection ‘C4’.

Further, the data receiving module 204 may be configured to provide the one or more extrinsic data parameters to the industry specific data processing module 208 via a connection ‘C2’. Upon receiving the one or more extrinsic data parameters, the industry specific data processing module 208 may be configured to processes the one or more extrinsic data parameters in order to identify variations in demand specific to industry in question, i.e., the target industry. In an embodiment, the one or more extrinsic data parameters may be considered particular to the target industry and may be used as pointers to explain variation in demand for the target industry. The one or more extrinsic data parameters may need to be contextualized specific to the target industry. The one or more extrinsic data parameters may include competitors and market data parameters, macroeconomic data parameters, socio-economic data parameters, consumer specific data parameters etc. as time series. In reference to above explanation in the present FIG. 2, the one or more extrinsic data parameters on collation may be represented as depicted via the equation (3). The industry specific data processing module 208 may be configured to provide the one or more extrinsic data parameters to the sparse multivariate data collation module 212 via a connection ‘C5’.

Further, the data receiving module 204 may be configured to provide the disruption data to the disruption data processing module 210. Upon receiving the disruption data, the disruption data processing module 210 may process the disruption data with disruption factors in order to identify a disruption-events within the reference time-period. Upon identifying the disruption event, the disruption data processing module 210 may be configured to provide information related with the identified disruption event to the disruption specific module 214 via a connection ‘C6’.

Upon receiving information related with the disruption event, the disruption specific module 214 may be configured to builds a disruption specific model. The disruption specific model may help to capture variation in the demand because of the disruption-event based on the information of the disruptive-event. As will be appreciated, the disruption specific model may be required in case when the identified disruption-event is not impulsive and may last for certain period of time, for instance, COVID-19, weather specific disruptions etc. In addition to building the disruption specific model, the disruption specific model may also be used for modeling based on impulsiveness of the disruption event. The built disruption specific model may be able to provide information related to the intensity of the disruption-event at any point of time. Moreover, the disruption specific model may provide information related with the duration of the disruption-event, i.e., time duration for which the disruption-event lasted with current trend in order to identify magnitude of impact of the disruption-event.

In an embodiment, the intensity and the duration information of the disruption event may help in performing what-if-analysis based on uncertainty of the disruption-event. Further, future projections may help in building the neural network model for demand projection. In reference to above explanation in the present FIG. 2, the disruption data may be represented as depicted via the equation (2). In an embodiment, the intensity of the disruption, ‘I’ at any point of time may be represented as depicted via equation (5) below:

I:[0,0,0 . . . ,Iₜ,Iₜ₊₁,Iₜ₊₂. . . ,Iₜ₊ₙ,0] (5)

In equation (5), ‘t’ may represent each point of time of the disruption-event, where ‘t’ depicts start time of the disruption-event. In addition, ‘t+n’ may represent end time of the disruption-event. Further, the duration of disruption, i.e., ‘D’ may be represented as depicted via equation (6) below:

D:[0,0,0 . . . ,Dₜ,Dₜ₊₁,Dₜ₊₂. . . ,Dₜ₊ₙ,0] (6)

In equation (6), ‘t’ may represent each point of time of the disruption-event, where ‘t’ depicts start time at which the disruption-event. In addition, ‘t+n’ may represent end time of the disruption-event. Upon identifying the intensity and the duration of the disruption-event, the disruption specific module 214 may be configured to provide this information to the sparse multivariate data collation module 212, via a connection ‘C7’.

The sparse multivariate data collation module 212 may be configured to receive the historical demand data, the one or more extrinsic data parameters, and the disruption data, from the intrinsic data processing module 206, the industry specific data processing module 208, and the disruption specific module 214 over the connection ‘C4’, ‘C5’, and ‘C7’ respectively. Upon collation of the historical demand data, the one or more extrinsic data parameters, and the disruption data, the sparse multivariate data collation module 212 may be configured to generate the sparse multivariate time series. Once the sparse multivariate time series is generated, the sparse multivariate data collation module 212 may be configured to provide the sparse multivariate time series to the demand prediction module 216 via a connection ‘C8’. The sparse multivariate time series may be provided to the demand prediction module 216 for training the neural network model for performing future demand prediction. In reference to FIG. 1, the neural network model may correspond to the ML model 104.

The demand prediction module 216 may be configured to train and build the neural network model that can provide demand prediction with maximum accuracy. In order to train the neural network model, the sparse multivariate time series may be used to generate the training data vectors. The generated training data vectors may be used as an input for the neural network model. The generated training data vectors may correspond to the final input as depicted via the equation (4). The neural network model may include a plurality of hidden layers for capturing localized and relevant sequence of the sparse multivariate time series in order to capture unexpected variations in the demand. In an embodiment, the neural network model may correspond to the forward-looking model that may adapt to new environment. In an embodiment, when path of the disruption-event starts recovering, the neural network model starts transitioning from newly adapted path to actual path by means of adjusting weight between historical path and new path formed based on the disruption data and the one or more extrinsic data parameters. Based on processing of the final input by the demand prediction module 216 via the neural network model, the output 220, i.e., the predicted demand may be generated and rendered at each point in time via an interface ‘I2’. Based on the output 220 generated, a loss function may need to be specified for each point in time within the reference time-period. Once the loss function is specified, the demand prediction module 216 may be configured to train the neural network model on provided inputs (i.e., the final inputs) until the specified loss function is minimized. Further, the demand prediction module 216 may be configured to share the predicted demand with the evaluation module 218 via a bidirectional connection ‘C9’.

The evaluation module 218 may be configured to receive the predicted demand from the demand prediction module 216 in order to evaluate the predicted demand against the actual demand. In order to evaluate the predicted demand for each store, product, or SKU, the evaluation module 218 may use a measurement unit, such as absolute percentage error. Based on the measurement unit, the evaluation module 218 may perform evaluation of the predicted demand to determine whether the magnitude of error of prediction is in line with business requirements. In other words, recovery path of the predicted demand may be evaluated against historic learning path in order to provide explainability for weights associated with the disruption-event which eventually fades off as values of the final input may change back to zero.

Further, the output 220 generated based on processing done by the demand prediction module 216 may represent prediction function with its shape equivalent to multi-step prediction parameter. The prediction function may be represented as: [P]_{(step×1)}, where ‘P’ is the function of [‘H’,‘I’,‘D,‘ID’].

An advantage of proposed mechanism unlike conventional mechanisms may be that the proposed mechanism leverages use of Artificial Intelligence (AI) to accurately forecast demand for various sales channels at any given point of time. This may be done by capturing impact of the disruption-event on changing consumer behavior and purchase patterns. By effectively capturing the demand, the proposed mechanism may provide AI-driven outcomes related to the SCM The AI-driven outcomes may include, but is not limited to, vendor and inventory management, pricing insights, and product prioritization strategies. As the AI-driven outcomes exists along upstream and downstream components of the supply chain, the proposed mechanism may provide organizations with the supply chain readiness and diversity against various types of disruption.

Additionally, the proposed mechanism may provide accurate demand prediction for different sales channels like stores, products, SKU's, retail, and e-commerce, by incorporating factors specific to the disruption-event and change in behavior of the consumer subjected to changing dynamics. Further, the historical demand data may be used in tandem with different types of industry and market data. Moreover, in order to understand functioning of the target industry, and economic and geographic specific dynamics during the disruption-event, the extrinsic data parameters may be used. The extrinsic data parameters may include, but is not limited to, competitors and market data parameters, macroeconomic data parameters, socio-economic data parameters, and consumer-specific data parameters associated with the target industry. As will be appreciated using the proposed mechanism, all collected information (i.e., the input 202) may be utilized using a novel methodology to capture relevant signals in the sparse multivariate time series. Moreover, an architecture used of the neural network model for the sparse multivariate time series model may provide accuracy for irregular sparse multivariate time series or when historical information is not available for some features.

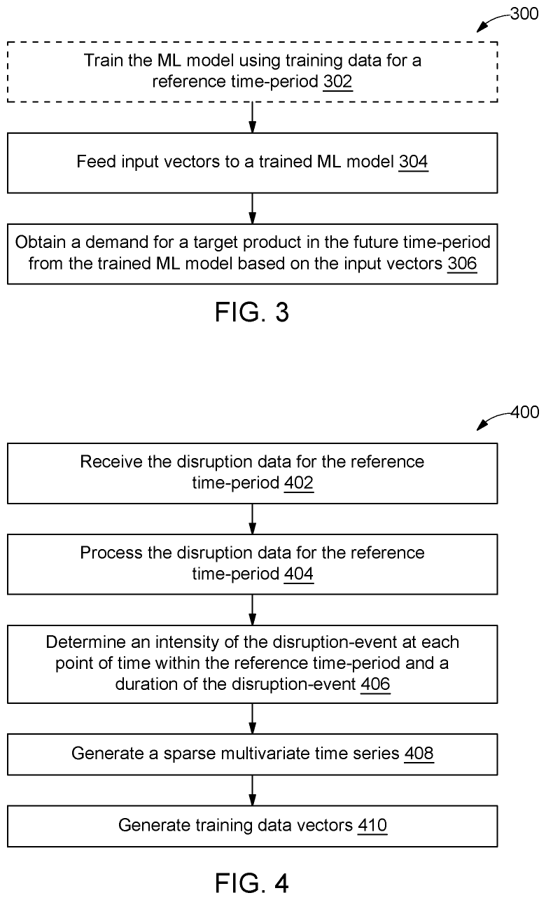

Referring now to FIG. 3, a flowchart of a method 300 for predicting demand for a supply chain is illustrated, in accordance with an embodiment. In order to predict the demand for the supply chain, initially at step 302, an ML model may be trained using training data for a reference period. In reference to FIG. 1, the ML model may correspond to the ML model 104. In an embodiment, the training data may include historical demand data for each point of time within the reference time-period, disruption data for the reference time-period, and one or more extrinsic data parameters for each point of time within the reference time-period, corresponding to the disruption data. The extrinsic data parameters may include, but is not limited to, competitors and market data parameters, macroeconomic data parameters, socio-economic data parameters, and consumer-specific data parameters associated with a target industry. With reference to FIG. 2, the training data may correspond to the input 202. Further, the historical demand data may also be referred historical sales data. The disruption data may also be referred as the disruption specific data, and the one or more extrinsic data parameters may also be referred as the industry specific data.

Once the ML model is trained, at step 304, input vectors may be fed to the trained ML model for a future time-period. The input vectors may include at least one of an intensity vector, a duration vector, and one or more extrinsic data vectors. In an embodiment, the intensity vector may correspond to an intensity of a possible disruption-event at each point of time within the future time-period. Further, the duration may correspond to the duration of the possible disruption-event. In addition, the one or more extrinsic data parameters may correspond to one or more possible extrinsic data parameters associated with each point of time within the future time-period. Upon feeding the input vectors to the trained ML model, at step 306, a demand for a target product in the future time-period may be obtained from the trained ML model based on the input vectors. In an embodiment, the target product may be associated with the target industry.

Referring now to FIG. 4, a flowchart of a method 400 for generating training data vectors is illustrated, in accordance with an embodiment. In reference to FIG. 3, as mentioned via the 302, in order to train the ML model, at step 402, the disruption data may be received for the reference time-period. Upon receiving the disruption data, at step 404, the disruption data may be processed for the reference time-period. In an embodiment, the processing of the disruption data may be done to analyze a disruption event within the reference time-period. Upon analyzing the disruption-event, at step 406, an intensity and a duration of the disruption event may be determined. It should be noted that, the intensity of the disruptive event may be determined at each point of time within the reference time-period. Once the intensity and the duration of the disruption event is determined, at step 408, a sparse multivariate time series may be generated. The sparse multivariate time series may be generated based on the training data for the reference time-period.

Upon generating the sparse multivariate time series, at step 410, training data vectors may be generated based on the sparse multivariate time series. The generated training data vectors may include a historical data vector, an intensity vector, a duration vector, and one or more extrinsic data vectors. In an embodiment, the historical data vector may be generated corresponding to historical demand data at each point of time within the reference time-period. Further, the intensity vector may be generated corresponding to the intensity of the disruption-event at each point of time within the reference time-period. In addition, the duration vector may be generated corresponding to the duration of the disruption-event. Moreover, the one or more extrinsic data vectors may be generated corresponding to one or more extrinsic data parameters at each point of time within the reference time-period.

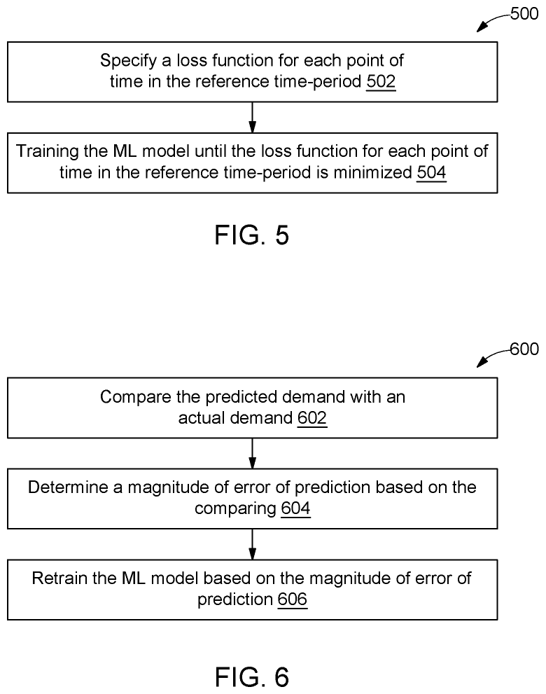

Referring now to FIG. 5, a flowchart of a method 500 for training a Machine Learning (ML) based on a loss function is illustrated, in accordance with an embodiment. In order to train the ML model to predict the demand for the target product accurately, at step 502, a loss function may be specified for each point of time in the reference time-period. The loss function may be specified to compare the predicted demand with the actual demand. In an embodiment, to learn weighted matrix ‘θ’ for each of the sparse multivariate time series in input matrix ‘IN’, different loss functions may be used. As will be appreciated, usage of different loss functions may allow to effectively capture differing relationships between each of the sparse multivariate time-series and the demand. However, usage of a single loss function may not be appropriate for all the sparse multivariate time-series. Hence, each input matrix, such as input matrix ‘IN₁’, input matrix ‘IN₂’ up to input matrix ‘INⱼ’ may be required to be mapped to a particular loss function, i.e., ‘L₁’, ‘L₂’ up to ‘Lᵢ’. Further, mapping of each input matrix with an associated loss function may be represented as depicted via equation (7) below:

{(IN₁,L₁(D_{actual},D_{predicted})), . . . ,(INᵢ,Lᵢ(D_{actual},D_{predicted}))} (7)

Once the loss function is specified, at step 504, the specified loss function may be used to train the ML model until the loss function for each point of time in the reference time-period is minimized. In other words, the specified loss function may be backpropagate to the ML model in order to adjust the weighted matrix ‘θ’. By way of an example, for each input matrix and the associated loss function, for example, (‘INᵢ’, ‘Lᵢ’) pair, the ML model may train itself until the loss function minimization is achieved. The minimized loss function may be represented as min Lᵢ(D_{actual}, D_{predicted}). Once all (‘INᵢ’, ‘Lᵢ’) pairs are backpropagated and the loss function minimization is achieved, the ML model may be ready for predicting the demand (also referred as demand forecasting). In reference to FIG. 2, the ML model may correspond to the ML model 104 (also referred as the neural network model).

Referring now to FIG. 6, a flowchart of a method 600 for retraining a ML based on magnitude of error of prediction is illustrated, in accordance with an embodiment. At step 602, the predicted demand may be compared with the actual demand. Based on comparison of the predicted demand with the actual demand, at step 604, a magnitude of error of prediction may be determined. In an embodiment, the comparison of the predicted demand with the actual demand may be done using various measurement units (for example, absolute percentage error). In other words, by using the absolute percentage error measurement unit for comparison of the predicted demand with the actual demand an evaluation may be done to determine whether the magnitude of error of prediction is in line with business requirement of the target industry for the target product. Once the magnitude of error of prediction is determined, at step 606, the ML model may be retrained based on the magnitude of error of prediction.

Once the ML model is trained, the trained ML model may be used to predict future demand as per the provided input vectors. The input vectors may include the intensity vector, the duration vector, and the one or more extrinsic data vectors. The trained ML model may be used to estimate both short term as well as long term demand based on business needs of the target industry. Further, depending upon uncertainty of the demand prediction for the future time-period, what-if-analysis may be simulated using the trained ML model. The what-if-analysis may be simulated based on factors considered for building the ML model and accordingly business outcomes (i.e., the demand prediction) may be obtained for supporting business decisions. Since the ML model is a forward-looking model, so at each stage, once the actual demand is available, the available actual demand may be incorporated in the input vectors as a feedback channel to update the ML model with latest behavior change and improve performance of the ML model. Further, the demand predictions available for various stores, products, SKU's from various channels and regions of the target industry, may be used to derive actionable insights in order to help in better decision making with respect to inventory planning, pricing of products, and sales strategy. In reference to FIG. 2, the predicted demand may be stored back in the sparse multivariate data collation module for performing future training of the ML model. In addition, the predicted demand is provided to the evaluation module for determining the magnitude of error of prediction.

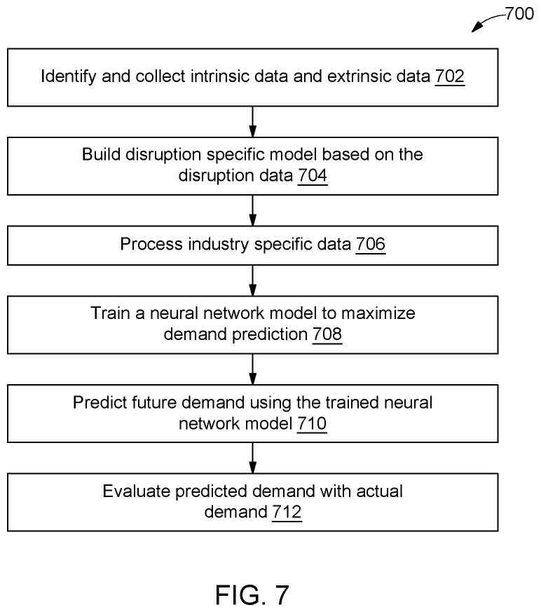

Referring now to FIG. 7, a detailed flowchart of a method 700 for predicting demand for a supply chain is illustrated, in accordance with an embodiment. At step 702, the intrinsic data and the extrinsic data may be identified and collected. In an embodiment, the intrinsic data may correspond to data internal to an organization. Whereas the extrinsic data may correspond to data external to the organization that may affect future demand. In reference to FIG. 3, the organization may correspond to the target industry. As explained in FIG. 2 above, the intrinsic data may include the historical demand data as the time series of the organization. The historical demand data may include the store-level data, the product-level data, and the SKU level data. The intrinsic data collected for the organization may be used to extract normal trends and patterns related to historical sales of the organization. Further, the extrinsic data may include the disruption data and the extrinsic data parameters. The extrinsic data parameters may include, but is not limited to, competitors and market data parameters, macroeconomic data parameters, socio-economic data parameters, and consumer-specific data parameters associated with a target industry. The extrinsic data parameters may be used to sense deviations from normal trends and adjust demand forecasts accordingly.

Upon identifying and collecting the intrinsic data and the extrinsic data, at step 704, the disruption specific model may be build based on the disruption data. In order to build the disruption specific model, the disruption data may be processed to identify the disruption-event that may be used by the disruption specific model. As explained in the FIG. 2 above, the disruption specific model may be able to provide information related to the intensity of the disruption-event at any point of time and the duration of the disruption-event, i.e., time duration for which the disruption-event lasted with current trend in order to identify magnitude of impact of the disruption-event.

Once the disruption specific model is build, at step 706, the one or more extrinsic data parameters (i.e., the industry specific data) may be processed to identify variations in the demand specific to the target industry. The one or more extrinsic data parameters may be considered particular to the target industry and are used as pointers to explain the variation in the demand for the target industry. The one or more extrinsic data parameters may need to be contextualized specific to the target industry. The extrinsic data parameters may include, but is not limited to, competitors and market data parameters, macroeconomic data parameters, socio-economic data parameters, and consumer-specific data parameters associated with the target industry. In reference to FIG. 2, upon collation of the one or more extrinsic data parameters, the one or more extrinsic data parameters may be represented as depicted via the equation (3).

Upon processing the one or more extrinsic data parameters, at step 708, the neural network model may be trained in order to obtain the demand prediction with maximum accuracy. In reference to FIG. 1, the neural network model may correspond to the ML model 104. In order to train the neural network model, the historical demand data, the disruption data, and the extrinsic data parameters may be collated to generate the sparse multivariate time series. Based on the generated sparse multivariate time series, the training data vectors may be generated. The generated training data vectors may correspond to the final input as depicted via the equation (4) of the FIG. 2.

In order to train the neural network model, the final input generated may be used as an input for the neural network model. The final input may be provided as an input matrix ‘IN’ to the neural network model. Further, upon receiving the final input, the neural network model may identify weights to express optimal relationship between each variable and demand. These weights can be represented via matrix θ as depicted via equation (8):

$$matrix θ = [ \begin{matrix}{θ}_{11} & … & {θ}_{i 1} \\ ⋮ & ⋱ & ⋮ \\ {θ}_{1 j} & … & {θ}_{ij}\end{matrix} ] \qquad ( 8 )$$

Upon receiving the input matrix ‘IN’ and the weight matrix ‘θ’, the neural network model may define a mapping between the input matrix ‘IN’ and the weight matrix ‘θ’ as represented via equation (9) below:

[P]_{(Step×1)}=f(IN;θ) (9)

In the above equation (9), ‘f’ may depict the function for mapping the input matrix ‘IN’ with the weight matrix ‘θ’. Once the mapping is generated, the neural network model may predict the demand (D) via ‘f(IN; θ)’ for each time-period ‘t’. The predicted demand (D) may be represented as depicted via equation (10) below:

{D_{predicted(t1)},D_{predicted(t2)}, . . . +D_{predicted(tn)}}- (10)

Once the neural network model is trained, at step 710, the trained neural network model may be used to predict the demand for the future time-period. In order to predict the demand, the input vectors may be fed as an input to the trained neural network model. In an embodiment, the input vectors may include the intensity vector, the duration vector, and the one or more extrinsic data parameters. Upon receiving the input vectors, the trained neural network model may obtain the demand for the target product in the future time-period. In other words, based on the received input vectors, the neural network model may be used to obtain the demand for both short term and long term based on business requirement of the target industry.

Since the neural network model is the forward-looking model, hence once the demand is obtained, the neural network model may be retrained based on the input vectors and the obtained demand in order to update the neural network model for a future time-period. The obtained demand for the stores, the products, or the SKU's from various channels may be used to derive actionable insights in order to make better decision with respect to inventory planning, pricing of products, and sales strategy.

Further, at step 712, the predicted demand (i.e., the obtained demand) may be compared against the actual demand by utilizing various measurements, e.g., absolute percentage error. The comparison is done to determine whether the magnitude of error of prediction is in line with the business requirements of the target industry. Based on the determination of the magnitude of error of prediction, the neural network model may be retrained. This has been already explained above in reference to the FIG. 2.

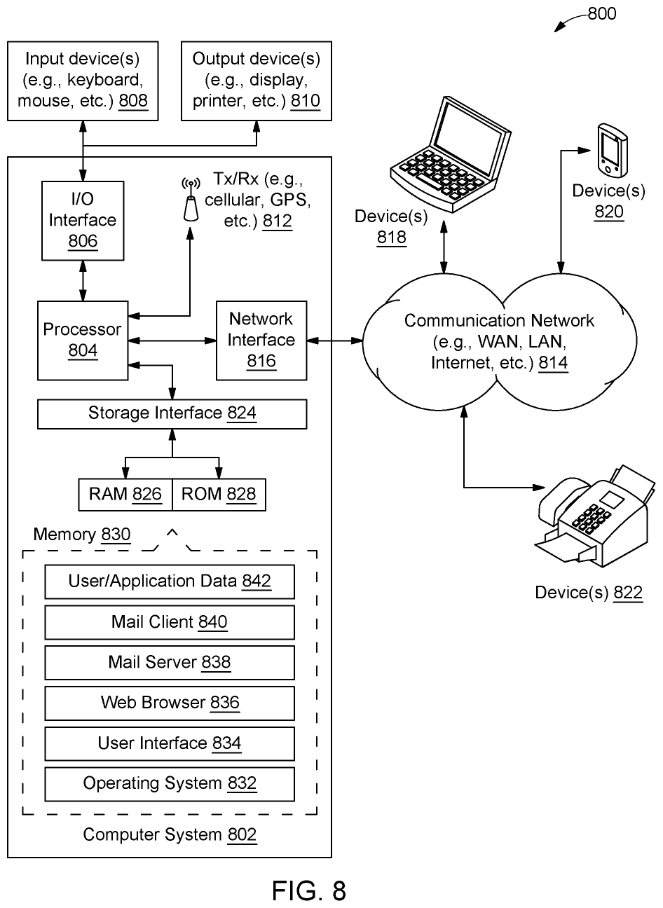

Referring now to FIG. 8, a block diagram 800 of an exemplary computer system 802 for implementing various embodiments is illustrated. Computer system 802 may include a central processing unit (“CPU” or “processor”) 804. Processor 804 may include at least one data processor for executing program components for executing user or system-generated requests. A user may include a person, a person using a device, such as those included in this disclosure, or such a device itself. Processor 804 may include specialized processing units such as integrated system (bus) controllers, memory management control units, floating point units, graphics processing units, digital signal processing units, etc. Processor 804 may include a microprocessor, such as AMD© ATHLOM® microprocessor, DURON© microprocessor OR OPTERON® microprocessor, ARM's application, embedded or secure processors, IBM© POWERPC©, INTEL'S CORE© processor, ITANIUM© processor, XEON© processor, CELERON© processor or other line of processors. Processor 804 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 804 may be disposed in communication with one or more input/output (1/O) devices via an I/O interface 806. The I/O interface 806 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM), long-term evolution (LTE), WiMax, or the like), etc.

Using I/O interface 806, computer system 802 may communicate with one or more I/O devices. For example, an input device 808 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 810 may be a printer, fax machine, video display (for example, cathode ray tube (CRT), liquid crystal display (LCD), light-emitting diode (LED), plasma, or the like), audio speaker, etc. In some embodiments, a transceiver 812 may be disposed in connection with processor 804. Transceiver 812 may facilitate various types of wireless transmission or reception. For example, transceiver 812 may include an antenna operatively connected to a transceiver chip (for example, TEXAS® INSTRUMENTS WILINK WL1286© transceiver, BROADCOM® BCM45501UB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 804 may be disposed in communication with a communication network 814 via a network interface 816. Network interface 816 may communicate with communication network 814. Network interface 816 may employ connection protocols including, without limitation, direct connect, Ethernet (for example, twisted pair 10/100/1000 Base T), transmission control protocol/internet protocol (TCP/IP), token ring, IEEE 802.11 a/b/g/n/x, etc. Communication network 814 may include, without limitation, a direct interconnection, local area network (LAN), wide area network (WAN), wireless network (for example, using Wireless Application Protocol), the Internet, etc. Using network interface 816 and communication network 814, computer system 802 may communicate with devices 818, 820, and 822. These devices may include, without limitation, personal computer(s), server(s), fax machines, printers, scanners, various mobile devices such as cellular telephones, smartphones (for example, APPLE© IPHONE® smartphone, BLACKBERRY® smartphone, ANDROID® based phones, etc.), tablet computers, eBook readers (AMAZON® KINDLE® reader, NOOK® tablet computer, etc.), laptop computers, notebooks, gaming consoles (MICROSOFT® XBOX® gaming console, NINTENDO© DS© gaming console, SONY® PLAYSTATION® gaming console, etc.), or the like. In some embodiments, computer system 802 may itself embody one or more of these devices.

In some embodiments, processor 804 may be disposed in communication with one or more memory devices (for example, RAM 826, ROM 828, etc.) via a storage interface 824. Storage interface 824 may connect to memory 830 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 830 may store a collection of program or database components, including, without limitation, an operating system 832, user interface 834, web browser 836, mail server 838, mail client 840, user/application data 842 (for example, any data variables or data records discussed in this disclosure), etc. Operating system 832 may facilitate resource management and operation of computer system 802. Examples of operating systems 832 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT©, UBUNTU®, KUBUNTU®, etc.), IBM© OS/2 platform, MICROSOFT® WINDOWS® platform (XP, Vista/7/8, etc.), APPLE© IOS® platform, GOOGLE® ANDROID® platform, BLACKBERRY® OS platform, or the like. User interface 834 may facilitate display, execution, interaction, manipulation, or operation of program components through textual or graphical facilities. For example, user interfaces may provide computer interaction interface elements on a display system operatively connected to computer system 802, such as cursors, icons, check boxes, menus, scrollers, windows, widgets, etc. Graphical user interfaces (GUls) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT© programming language, AJAX® programming language, HTML, ADOBE® FLASH® platform, etc.), or the like.

In some embodiments, computer system 802 may implement a web browser 836 stored program component. Web browser 836 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APIs), etc. In some embodiments, computer system 802 may implement a mail server 838 stored program component. Mail server 838 may be an Internet mail server such as MICROSOFT© EXCHANGE© mail server, or the like. Mail server 838 may utilize facilities such as ASP, ActiveX, ANSI C++/C#, MICROSOFT .NET® programming language, CGI scripts, JAVA© programming language, JAVASCRIPT® programming language, PERL® programming language, PHP® programming language, PYTHON© programming language, WebObjects, etc. Mail server 838 may utilize communication protocols such as internet message access protocol (IMAP), messaging application programming interface (MAPI), Microsoft Exchange, post office protocol (POP), simple mail transfer protocol (SMTP), or the like. In some embodiments, computer system 802 may implement a mail client 840 stored program component. Mail client 840 may be a mail viewing application, such as APPLE MAIL® mail-client, MICROSOFT ENTOURAGE® mail client, MICROSOFT OUTLOOK® mail client, MOZILLA THUNDERBIRD® mail client, etc.

In some embodiments, computer system 802 may store user/application data 842, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

Various embodiments provide method and system for predicting demand for a supply chain. The disclosed method and system may feed input vectors to a trained Machine Learning (ML) model for a future time-period. The input vectors may at least one of: an intensity vector corresponding to an intensity of a possible disruption-event at each point of time within the future time-period, a duration vector corresponding to the duration of the possible disruption-event, and one or more extrinsic data vectors corresponding to one or more possible extrinsic data parameters associated with each point of time within the future time-period. Further, the disclosed method and system may obtain a demand for a target product in the future time-period from the trained ML model based on the input vectors.

The method and system provide some advantages like, the method and system may capture impact of various disruption event on future demand by providing forecast for performing detailed level of analysis related to stores, products, or SKU's. Further, the method and system may enable user to easily capture impact of disruption event due to use of Artificial Intelligence in time-modelling. In addition, the method and system may provide higher accuracy in determination of impact of disruption event during the disruption event and after completion.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of predicting demand for a supply chain, the method comprising:
for a future time-period, feeding, by a predicting device, input vectors to a trained Machine Learning (ML) model, wherein the input vectors comprise at least one of:
an intensity vector corresponding to an intensity of a possible disruption-event at each point of time within the future time-period;
a duration vector corresponding to the duration of the possible disruption-event; and
one or more extrinsic data vectors corresponding to one or more possible extrinsic data parameters associated with each point of time within the future time-period; and
obtaining, by the predicting device, a demand for a target product in the future time-period from the trained ML model based on the input vectors.

2. The method of claim 1 further comprising training the ML model using training data for a reference time-period, the training data comprising:
historical demand data for each point of time within the reference time-period;
disruption data for the reference time-period; and
one or more extrinsic data parameters for each point of time within the reference time-period, corresponding to the disruption data.

3. The method of claim 2 further comprising:
receiving the disruption data for the reference time-period;
processing the disruption data for the reference time-period to analyze a disruption-event within the reference time-period; and
determining:
an intensity of the disruption-event at each point of time within the reference time-period; and
a duration of the disruption-event.

4. The method of claim 2, wherein training the ML model further comprises:
generating a sparse multivariate time series based on the training data for the reference time-period.

5. The method of claim 4, wherein training the ML model further comprises generating training data vectors based on the sparse multivariate time series, wherein the training data vectors comprise:
a historical data vector corresponding to historical demand data at each point of time within the reference time-period;
an intensity vector corresponding to the intensity of the disruption-event at each point of time within the reference time-period;
a duration vector corresponding to the duration of the disruption-event; and
one or more extrinsic data vectors corresponding to one or more extrinsic data parameters at each point of time within the reference time-period.

6. The method of claim 1, wherein the extrinsic data parameters comprise: competitors and market data parameters, macroeconomic data parameters, socio-economic data parameters, and consumer-specific data parameters associated with a target industry, wherein the target product is associated with the target industry.

7. The method of claim 1, training the ML model further comprises:
comparing the predicted demand with an actual demand;
determining a magnitude of error of prediction based on the comparing; and
retraining the ML model based on the magnitude of error of prediction.

8. The method of claim 1, wherein training the ML model further comprises:
specifying a loss function for each point of time in the reference time-period, wherein the loss function is to compare the predicted demand with the actual demand; and
training the ML model until the loss function for each point of time in the reference time-period is minimized.

9. A system for predicting demand for a supply chain, the system comprising:
a processor; and
a memory communicatively coupled to the processor, wherein the memory stores processor-executable instructions, which, on execution, causes the processor to:
for a future time-period, feed input vectors to a trained Machine Learning (ML) model, wherein the input vectors comprise at least one of:
an intensity vector corresponding to an intensity of a possible disruption-event at each point of time within the future time-period;
a duration vector corresponding to the duration of the possible disruption-event; and
one or more extrinsic data vectors corresponding to one or more possible extrinsic data parameters associated with each point of time within the future time-period; and
obtain a demand for a target product in the future time-period, from the trained ML model, based on the input vectors.

10. The system of claim 9, wherein the processor-executable instructions further cause the processor to:
train the ML model using training data for a reference time-period, the training data comprising:
historical demand data for each point of time within the reference time-period;
disruption data for the reference time-period; and
one or more extrinsic data parameters for each point of time within the reference time-period, corresponding to the disruption data.

11. The system of claim 10, wherein the processor-executable instructions further cause the processor to:
receive the disruption data for the reference time-period;
process the disruption data for the reference time-period to analyze a disruption-event within the reference time-period; and
determine:
an intensity of the disruption-event at each point of time within the reference time-period; and
a duration of the disruption-event.

12. The system of claim 10, wherein, to train the ML model, the processor-executable instructions further cause the processor to:
generate a sparse multivariate time series based on the training data for the reference time-period.

13. The system of claim 12, wherein, to train the ML model, the processor-executable instructions further cause the processor to:
generate training data vectors based on the sparse multivariate time series, wherein the training data vectors comprise:
a historical data vector corresponding to historical demand data at each point of time within the reference time-period;
an intensity vector corresponding to the intensity of the disruption-event at each point of time within the reference time-period;
a duration vector corresponding to the duration of the disruption-event; and
one or more extrinsic data vectors corresponding to one or more extrinsic data parameters at each point of time within the reference time-period.

14. The system of claim 9, wherein the extrinsic data parameters comprise: competitors and market data parameters, macroeconomic data parameters, socio-economic data parameters, and consumer-specific data parameters associated with a target industry, wherein the target product is associated with the target industry.

15. The system of claim 9, wherein, to train the ML model, the processor-executable instructions further cause the processor to:
compare the predicted demand with an actual demand;
determine a magnitude of error of prediction based on the comparing; and
retrain the ML model based on the magnitude of error of prediction.

16. The system of claim 9, wherein, to train the ML model, the processor-executable instructions further cause the processor to:
specify a loss function for each point of time in the reference time-period, wherein the loss function is to compare the predicted demand with the actual demand; and
train the ML model until the loss function for each point of time in the reference time-period is minimized.

17. A non-transitory computer-readable storage medium for predicting demand for a supply chain, having stored thereon, a set of computer-executable instructions causing a computer comprising one or more processors to perform steps comprising:
for a future time-period, feeding input vectors to a trained Machine Learning (ML) model, wherein the input vectors comprise at least one of:
an intensity vector corresponding to an intensity of a possible disruption-event at each point of time within the future time-period;
a duration vector corresponding to the duration of the possible disruption-event; and
one or more extrinsic data vectors corresponding to one or more possible extrinsic data parameters associated with each point of time within the future time-period; and
obtaining a demand for a target product in the future time-period from the trained ML model based on the input vectors.
